(19) United States
(12) Patent Application Publication
(10) Pub. No.: US 2006/0187205 A1
(43) Pub. Date: Aug. 24, 2006

(54) APPARATUS AND ASSOCIATED METHOD FOR WIRELESS COMPUTING SYSTEMS

(76) Inventor: Blaine Rexel Bateman, Louisville, CO (US)

Correspondence Address: HOLLAND & HART, LLP, P.O BOX 8749, DENVER, CO, 80201, US

(21) Appl. No.: 10/906,428

(22) Filed: Feb. 18, 2005

(51) Int. Cl. G09G 5/08

(52) U.S. Cl. 345/163; 345/157

(57) ABSTRACT

The present invention provides a peripheral device for establishing radio frequency communication links between peripheral devices using wireless protocols. Preferably, the peripheral includes radio frequency electronics and peripheral electronics connected to universal serial bus hub that is further connected to the universal serial bus port on the computer.

### FIELD OF THE INVENTION

This invention relates to wireless communication between computing devices and peripherals and more particularly to integrating a low powered wireless communicating device into a wired one of those peripherals

### BACKGROUND OF THE INVENTION

Generally, computing devices are connected to peripheral or external devices using direct communication links such as, for example, cables and buses. Information and data is transferred over the cables and buses using various bus protocols. One particular protocol is known as the universal serial bus (“USB”). USB allows several devices to be connected to the computer through the same bus.

FIG. 1 shows a conventional computing system 100 connecting a processor 110 using USBs to peripheral devices. Computer 100 includes connections to a first USB hub 130 and a second USB hub 140. First USB hub 130 has connectors or ports 132, 134, 136, and 138. Second USB hub 140 has connectors or ports 142, 144, 146, and 148. Ports 132, 134, 136, 138, 142, 144, 146, and 148 are used to connect peripheral (not shown) and external devices to the host 110. Typically, personal computers (“PCs”) only have two USB ports.

Currently, low power radio frequency connectivity between devices for data and voice communication is being explored by many residential and commercial businesses. For example, one Specification for Wireless Connectivity, known as Bluetooth technology, allows for wireless transmission of data and voice using a low power short-range radio link. Currently, the electronics and software for providing bluetooth technology to existing systems is contained in a bluetooth base unit. In particular, the bluetooth technology allows wireless communication links to replace direct communication links that use cables and buses, as described above.

When using bluetooth technology, two or more digital devices are linked by low power radio frequencies to establish a “piconet.” While each device contains similar bluetooth base units, the digital device initiating the wireless communication link becomes the master unit, and the other device(s) become the slave unit(s). Thus, the master or initiating unit exists to synchronize the sequences between the different slaves with the master.

Due to the low power, however, integrating the bluetooth base unit directly into a main unit or chassis of a PC is not satisfactory because the bluetooth base unit does not have sufficient power to penetrate the PC chassis and any other barrier, such as a desk top. Attempting to connect an external bluetooth base unit to the chassis is also unsatisfactory because it requires use of one of the two USB ports available in the typical PC. Thus, it would be beneficial to connect the bluetooth base unit external to the PC chassis without using one of the two USB ports available in the typical PC. These difficulties exist with other low power radio frequency protocols also. In particular, there exist many applications using the 802.11 protocol for longer-range wireless communications, which have the same difficulties as described.

### SUMMARY OF THE INVENTION

To attain the advantages and in accordance with the purpose of the invention, as embodied and broadly described herein, a computing system using wireless communication is provided. The computing system includes a computer in a main chassis that has a port adapted for communication between the computer and a first peripheral. A wireless communication device is integrated into the first peripheral device and adapted to establish wireless communication with other peripheral device. A non-wireless communication link exists to establish a connection between the computer and the first peripheral device.

The foregoing and other features, utilities and advantages of the invention will be apparent from the following more particular description of a preferred embodiment of the invention as illustrated in the accompanying drawings.

### BRIEF DESCRIPTION OF THE DRAWINGS

The objects, features, and advantages of the present invention will be apparent from the following detailed description of the preferred embodiment of the invention with reference to the following drawings:

FIG. 1 is a functional block diagram of a computing device including universal serial bus technology;

FIG. 2 is a functional block diagram of a typically personal computer including universal serial bus technology and at least one peripheral;

FIG. 3 is a functional block diagram of a personal computer including universal serial bus technology and at least one peripheral and a bluetooth base unit;

FIG. 4 is a functional block diagram integrating a bluetooth base unit into a peripheral device using universal serial bus technology; and

FIG. 5 is a functional block diagram showing a bluetooth peripheral separated for a personal computer main chassis by a barrier.

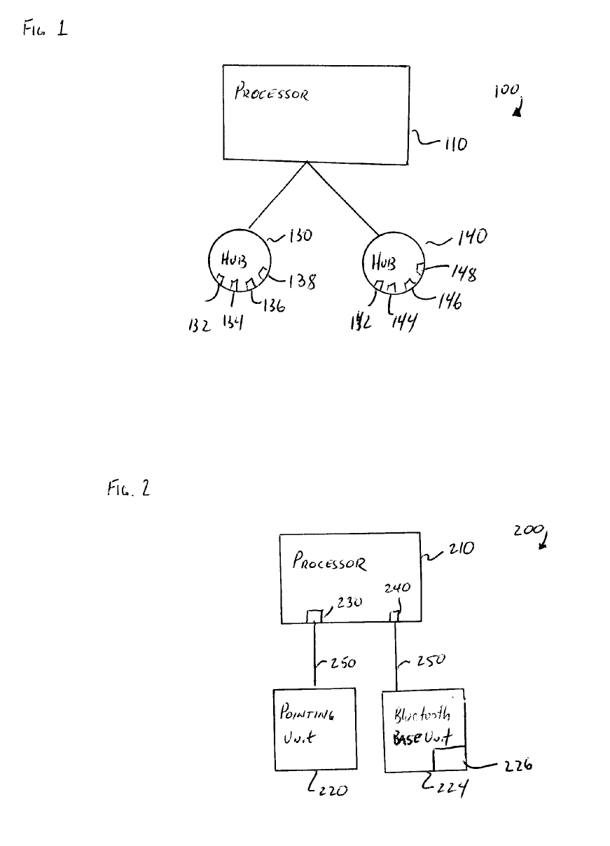

### DETAILED DESCRIPTIONS

Wireless Protocols.

Presently there are many wireless communication protocols in commerical use. Examples include Bluetooth, 802.11 (WiFi), 802.16, Zigbee, UWB (Ultra Wide Band), or the like. In the present invention, any one of these protocols may be integrated into a wired peripheral to allow wireless peripherals to connect to a PC.

Wireless Peripherals.

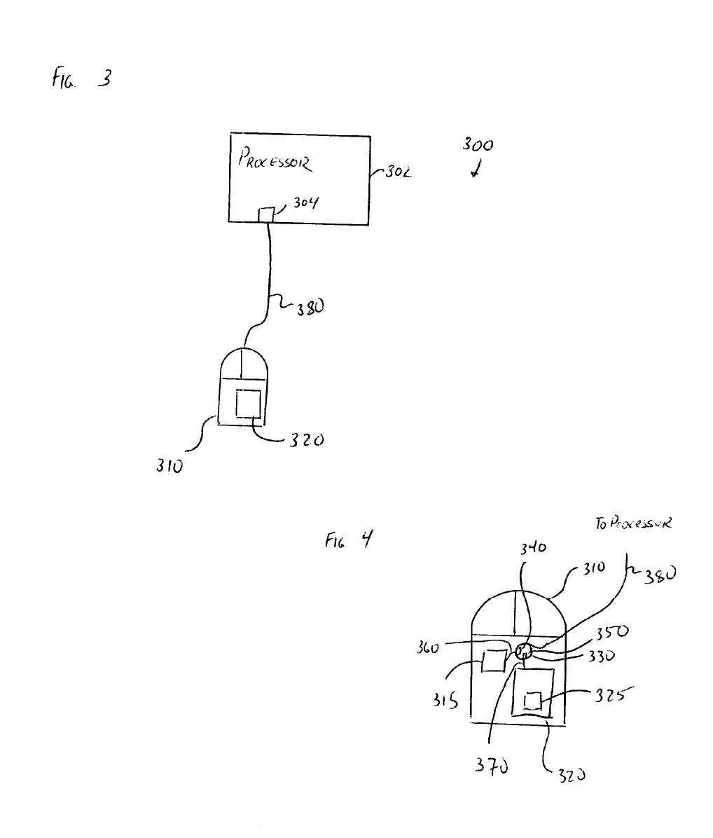

The present invention discloses an apparatus that integrates wireless technology into a peripheral device of a computing device. While this invention is described with particular reference to bluetooth technology, one of skill in the art would now recognize that 802.11 (WiFi) or other wireless protocols could be used as the low power radio frequency protocol. FIG. 2 shows a computing system 200 having a host processor 210 and at least one peripheral 220 connected to a first USB port 230. For example, peripheral 220 could be a pointing unit or mouse. Additionally, other peripherals, such as a keyboard 224, could be connected to host computer 210 at a second USB port 240. The number of peripherals is limited by the number of ports available. A USB cable 250 connects each peripheral 220 and 224 to host computer 210. To establish wireless connectivity, second peripheral 224 may be a bluetooth base unit.

Bluetooth base unit 224 has bluetooth electronics and software 226. As FIG. 2 shows, separately connecting bluetooth base unit 226 to processor 210 uses one a USB port, which is half of the USB ports available on typical computers.

Referring now to FIG. 3, a computing system 300 having a processor 302 is shown. Processor 302 has a port 304 connecting a mouse 310 to processor 302. Notice port 304 may be a USB port for a USB mouse, or a port configured for mouse 310. Bluetooth base unit 320 is integrated into mouse 310 and connected to processor 302 via port 304. While FIG. 3 shows integrating bluetooth base unit 320 into mouse 310, bluetooth base unit 320 could be integrated into any peripheral such as a keyboard, printer, track ball, or other pointing device (not shown). Bluetooth base unit 320 maybe integrated in a wired device that is connected to processor 302 via a non-USB port, although a peripheral using a USB port is also a satisfactory solution.

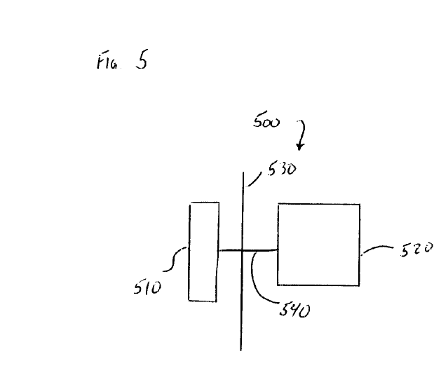

FIG. 4 shows mouse 310 with integrated bluetooth base unit 320 in more detail. Mouse 310 has mouse electronics and software 315 and bluetooth electronics and software 325 housed in bluetooth base unit 320 (notice bluetooth base unit 320 is shown for ease of reference, but is not a necessary physical boundary between the bluetooth electronics and software and the mouse electronics and software). Mouse electronics and software 315 and bluetooth electronics and software 325 are connected to a hub 330 through first and second ports 340 and 350, respectively, using first and second cables 360 and 370, respectively. Hub 330 in mouse 310 is connected to host 302 using cable 380 in a conventional manner. Thus, mouse 310 and bluetooth base unit 320 use only one port and at most only one of the available USB ports. This leaves the other USB free for other uses.

Additionally, by integrating the bluetooth technology into, for example, mouse 310, the PC chassis can be removed or separated from the work area. FIG. 5 shows workstation 500 having a PC chassis 510 separated from a bluetooth peripheral 520 by a barrier 530. Barrier 530 could be, for example, a desk top, wall, or the like. Bluetooth peripheral 520, which is preferably a mouse, is connected to PC chassis 510, and PC electronics contained in PC chassis 510 not shown, using a cable 540 that spans from peripheral 520 to chassis 510 through or around barrier 530. Other peripherals, not shown, would communicate with the electronics contained in PC chassis 510 by establishing a wireless communication network with bluetooth peripheral 520. One of ordinary skill in the art would recognize that cable 540 could be replaced by a wireless communication link of sufficient power, i.e., high power, to penetrate the barrier(s) and PC chassis 510.

As shown in FIG. 5, one great advantage of placing the bluetooth module in the bluetooth peripheral 520, such as, for example, a mouse, is that the mouse typically is positioned on the desk near to the user and in an open work area. Thus, the connectivity from the mouse's bluetooth module to other peripherals close to the user and in the bluetooth module's functioning range is both better and more reliable. The other peripherals could be, for example, a keyboard, a monitor, a printer, a facsimile, a copier, etc. Of course, while the above was explained assuming bluetooth peripheral 520 was a mouse, other peripheral devices could house master bluetooth modules. For example, the bluetooth module could be located in the keyboard, the monitor, or any other peripheral located in an environment where the bluetooth module can establish a communication link with other peripherals.

As one of ordinary skill in the art would recognize based on the above descriptions, the functions of the bluetooth base unit and peripherals could be implemented using circuit hardware, software or firmware, or some combination thereof. In the preferred embodiment, portions of the functionality of the bluetooth technology are performed using a combination of hardware and software to drive the base unit.

A presently preferred embodiment of the present invention and many of its improvements have been described with a degree of particularity. It should be understood that this description has been made by way of example, and that the invention is defined by the scope of the following claims.

What is claimed is:

1. A wireless computing system, comprising:
a computer in a main chassis wherein the main chassis has at least one peripheral communication port;
a first peripheral device coupled to the peripheral communication port having a radio frequency wireless communicating device integrated into the first peripheral device adapted to establish at least one radio frequency wireless communication link with at least one other peripheral device; and
the first peripheral device connected to the at least one peripheral communication port by a non-wireless communication link.

2. The computing system according to claim 1 wherein the non-wireless communication link uses universal serial bus protocols.

3. The computing system according to claim 1 wherein that at least one radio frequency wireless communication link is established using low power radio frequency.

4. The computing system according to claim 1 wherein the first peripheral device is a mouse.

5. The computing system according to claim 1 wherein the first peripheral device includes:
a hub having at least a first and second port;
peripheral electronics connected to the first port; and
wireless electronics connected to the second port.

6. The computing system according to claim 5 wherein the main chassis is separated from the first peripheral by a barrier.

7. A wireless peripheral device, comprising:
a hub integrated into the peripheral device having at least a first and second port;
wireless electronics integrated into the peripheral device and connected to the first port are adapted to establish radio frequency wireless communication links with at least one other peripheral device;
peripheral device electronics connected to the second port; and
the hub to be connected the wireless peripheral to a computer.

8. The wireless peripheral device according to claim 7 wherein the wireless protocols use low power radio frequency.

9. The wireless peripheral device according to claim 7 wherein:
the wireless peripheral is adapted to be connected to the computer through at least one barrier; and
the hub is adapted to be connected to the computer using high-power wireless communication links.

10. A wireless computing system, comprising:
a computer in a main chassis wherein the main chassis has a high power wireless communication device adapted for communication between the computer and a first peripheral;
the first peripheral device having a peripheral wireless communicating device integrated into the first peripheral device, the peripheral wireless communication device having a high power portion and a low power portion;
the low power portion of the peripheral wireless communication device adapted to establish low power radio frequency communication links with other peripheral devices; and
the high power portion of the peripheral wireless communication device adapted to establish a high power communication link with the high power wireless communication device of the computer.
